(19) United States
(12) Patent Application Publication
(10) Pub. No.: US 2007/0040652 A1
(43) Pub. Date: Feb. 22, 2007

(54) Entertainment paging system and method

(76) Inventor: Cary Quatro, Byron Center, MI (US)

Correspondence Address: ROBERT J. SAYFIE, P.C., 161 OTTAWA AVENUE NW, SUITE 407, GRAND RAPIDS, MI, 49503, US

(21) Appl. No.: 11/209,077

(22) Filed: Aug. 22, 2005

(51) Int. Cl. G08B 5/22; H04Q 7/00

(52) U.S. Cl. 340/7.55; 714/749; 340/286.09; 705/15; 463/40

(57) ABSTRACT

A system having a console and remote media device. The console transmits a page to the remote media device. The console may also be used to synchronize the remote media device. Alternatively, a docking station may be used for synchronization or recharging for the power source of the remote media device. The remote media device may be used in a restaurant by patrons while waiting for a table. In this environment the remote media device may have video games, magazines coupled with advertising, which would allow a patron that is waiting for a table to play a video game. The remote media device may have a configuration that includes a protective screen that overlays a recessed video screen to prevent food particles or liquid from penetrating the remote media device.

### BACKGROUND OF THE INVENTION

The present invention relates to a wireless paging system that can incorporate a video game into a remote media device.

Relevant art includes a device called “PlayCall” sold by NTN Communications, Inc. (www.ntn.com). The PlayCall is a product advertised as a wireless restaurant pager or coaster. The PlayCall has 5 games.

When going to restaurants, it is common to have to wait to eat due to the full capacity of the tables or eating area. When the restaurant seating capacity is full, a hostess may take a patron's name, and have the patron wait in a lobby or bar. Then when the hostess is ready to seat the patron, the hostess can yell out the person's name. Some restaurants will provide a pager or coaster to the patron. Or, if the patron is provided with a pager, the hostess can “call” the pager, which causes the pager to vibrate or become illuminated, or both. Each pager has a unique or separate ID on the system, so that the paging equipment will notify the correct pager and patron. Then the patron can walk from the lobby, bar, or wherever they were waiting, to the hostess, who will take the pager, and seat the patrons. After taking the pager, the hostess resets or turns of the pager for future use.

During this wait time, it is common for people to stand in a lobby, near the entryway, or at a bar and wait to be summoned by the hostess. This wait time can be boring for the patron, and in some cases, the patron leaves, thus the restaurant loses a customer. Further, those with small children have to labor to restrain or corral the children and maintain order. Otherwise the children may find interest in the decor or utilitarian instruments within sight, whether that be a hostess stand, a fireplace, or an otherwise non-child friendly environment.

One restaurant named Heroe's@, located in Grand Rapids, Mich. provides portable Nintendo® DS gaming devices for it's patrons, which can be used while the patron waits for its table, or after being seated at the table.

Other environments where patrons or clients are subject to long wait periods include hospitals or amusement parks.

As can be seen, there is a need for a paging device that can also allow for local video game playing and advertising.

### SUMMARY OF THE INVENTION

An aspect of this present invention is a method for rendering media content on a remote media device, comprising: providing a console, said console capable of processing program instructions and sending a page; communicating said processed program instructions over a communication link; communicating said page over a wireless communication link; and receiving said processed program instructions and said page at said remote media device, said remote media device capable of generating operations of said remote media device, said remote media device capable of activating as the result of receiving said page.

Another aspect of the present invention is an entertainment paging systems, comprising: a console having a central processing unit that is capable of receiving, storing, and transmitting media content, said console also capable of sending a wireless page; and a remote media device capable of receiving said page from said console, said remote media device also capable of allowing a user to interact with said media content.

Yet another aspect is an entertainment paging system, comprising: a console having a central processing unit, said console capable of receiving, storing, and transmitting media content said console also capable of sending a wireless page; and a remote media device capable of receiving said page from said console, said remote media device also capable of interactive output of said media content.

These and other features, aspects and advantages of the present invention will become better understood with reference to the following drawings, description and claims.

### BRIEF DESCRIPTION OF THE DRAWINGS

FIG. 1 illustrates a block diagram of an exemplary embodiment of an entertainment paging system of the present invention;

FIG. 2 illustrates another block diagram of an exemplary embodiment of the system;

FIG. 3 illustrates an exemplary embodiment of the remote media device of the present invention as a hand-held device;

FIG. 4 illustrates another exemplary embodiment of the remote media device of the present invention as a tablet;

FIG. 5 illustrates the docking station for the console and the remote media device; and

FIG. 6 illustrates exemplary features of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

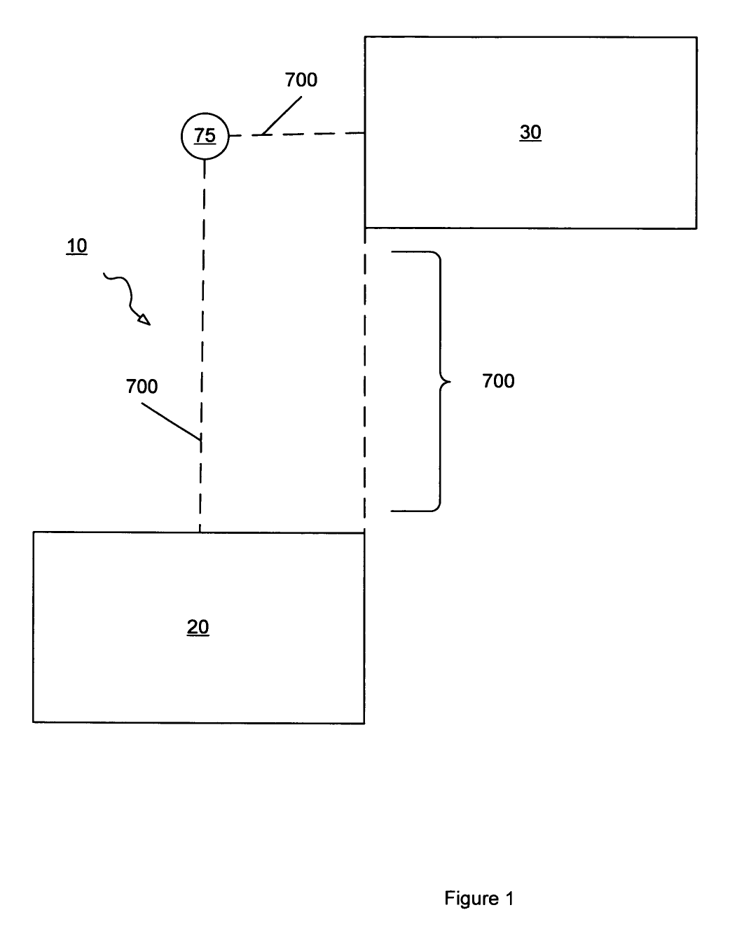

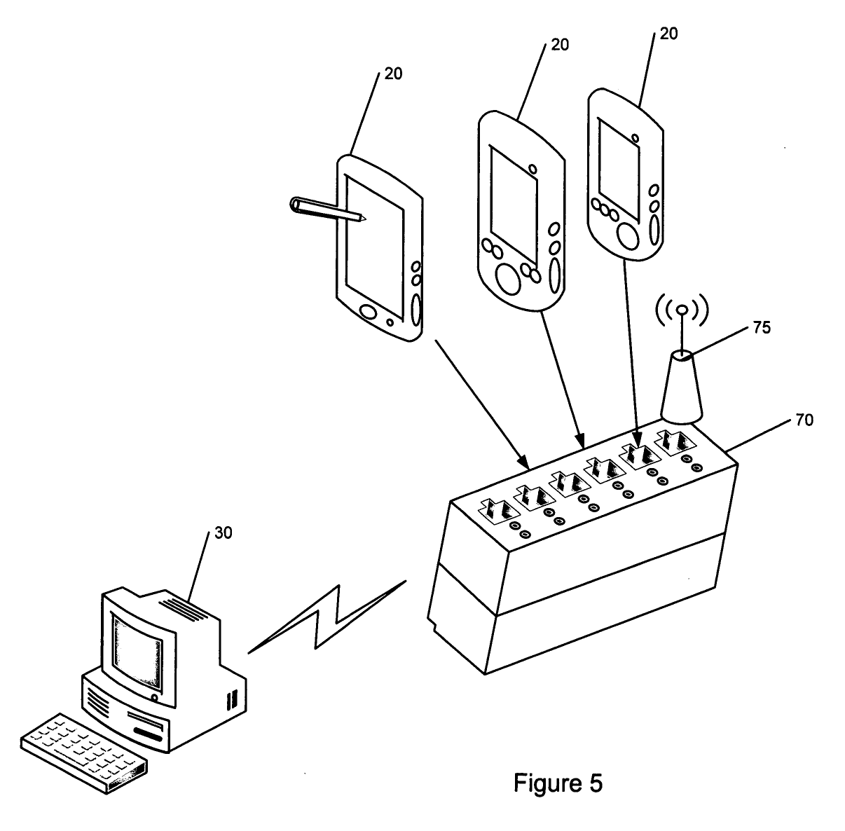

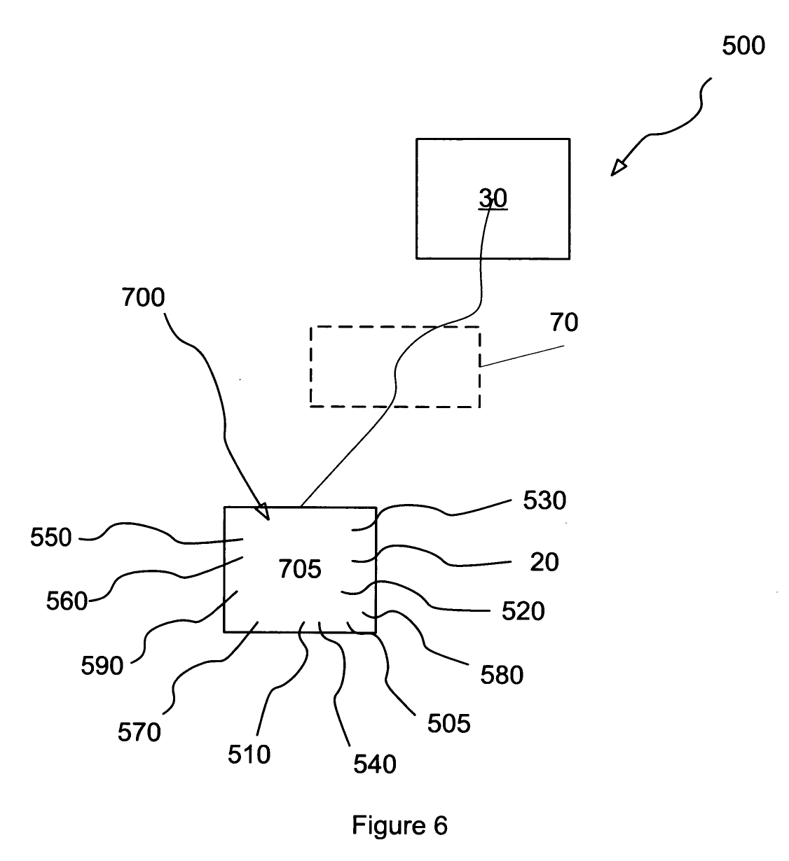

As illustrated in FIG. 1, an invention is disclosed for a remote paging system 10 and a method 500 (FIG. 6) for at least a wireless link for a page or paging function, and in one exemplary embodiment, an additional wireless link that may be created between a remote media device 20 and a console 30. In one exemplary embodiment of the present invention, the remote media device 20 may be a restaurant pager with additional features described herein. For this function (the paging function) of the present invention, a wireless link would be necessary between the console 30 and the remote media device 20. A suitable transmitter capable of such communication may the PTX100-100 watt paging transmitter from Commtech Wireless, which may support UHF and VHF transmission. Other suitable transmitters include Microframe's DataPage Lite UHFNHF transmitter and coaster system; NTN's Play Call or Smart Call Paging system with a UHFNHF paging transmitter; or J-Tech's Guest Call System. This list is only exemplary, and not inclusive of all possible transmitters. The present invention can be a new manufacture, or a newly assembled system; or it can be retrofitted with existing restaurant paging systems. In one exemplary embodiment that may be illustrated in FIG. 5, the console 30 may have a central processing unit, such as a personal computer (PC), and capable of receiving, storing, transmitting, processing and communicating media content 700, also referred to herein as program instructions 700. Advertising information that can be viewed on the screen of a portable media device or remote media device 20 is one exemplary embodiment of this present invention. The console 30 may communicate the processed program instructions 700 over a communication link (wireless or wired) with the remote media device 20. Therefore, if a patron is sitting down waiting for his table, he may be playing a video game with the remote media device 20, while advertising is scrolling across a portion of the screen. In one exemplary embodiment, the console 30 may communicate with the remote media device 20 via transceivers capable of sending and receiving content 700 such as web based programs. One such transmitter or transceiver suitable for such use may be the IntelPage IP from Commtech Wireless. In one exemplary embodiment the content 700, also known as processed program instructions 700 may be organized to be in an intranet (only accessed by that particular internal network) or Internet (accessed by external network) framework, which would allow the system to update or add content 700 to the remote media device 20 by simply updating the pages and their content 700 on a periodic basis. An example would be for magazines such as Sports lllustrated® that are updated weekly; the system may add a new page or set of pages for each new edition's articles and content 700.

The remote media device 20 may receive the processed program instructions 700. The processed program instructions 700 may at least partially drive or generate operations 705 (FIG. 6), such as paging/gaming operations 705, such as vibration, video, audio, and control data to display graphics on a display of the remote media device 20.

In another exemplary embodiment, which may be illustrated in FIG. 5, the console 30 has communication capability (wireless or wired) with a cradle or docking station 70. The docking station 70 is adapted to receive or cradle the remote media device 20 and for charging of a rechargeable battery within the remote media device 20. The docking station 70 could also be equipped with a wireless access point 75 to transmit the paging signals or media content 700 to the remote media device 20, as illustrated in FIG. 1. This may expand the frequency range. The paging is usually live. This means that the hostess can activate the remote media device 20 from the hostess stand. When the remote media device 20 is activated, it may vibrate or otherwise alert the patron.

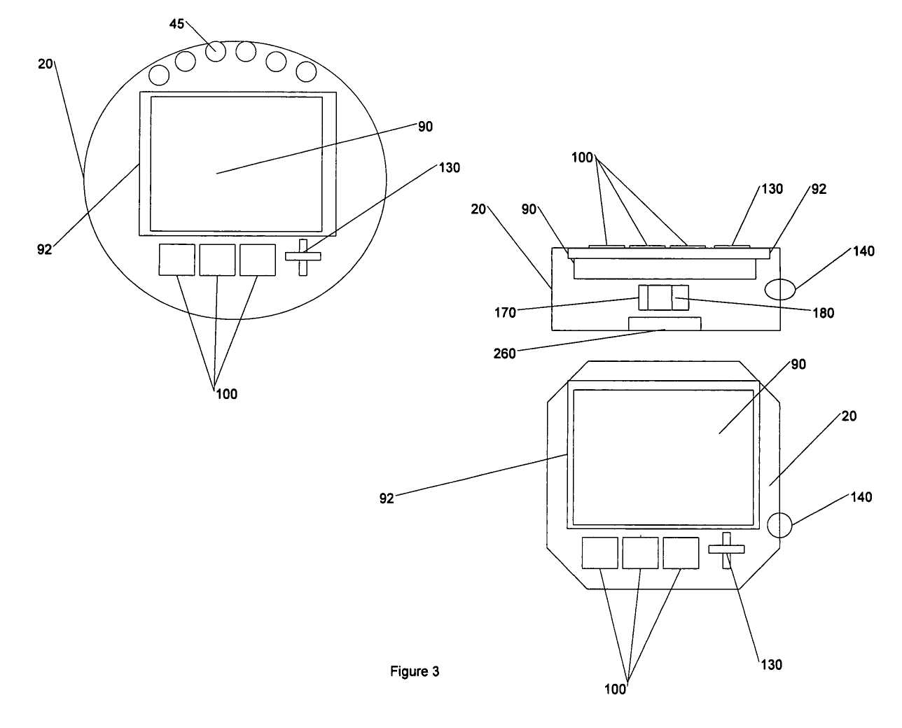

The remote media device 20 is capable of playing media content 700 and of receiving paging signals via a media feature 550 and a paging feature 560. The paging feature may activate light emitting diode (LED) style lights 45 (FIG. 3) to blink or the remote media device 20 to vibrate to page patrons. Vibration may occur by the same vibrating device presently used in cellular telephones. In a further exemplary embodiment, a port 260 of the remote media device 20 may be an expansion card slot capable of receiving a card that could be housed externally to stimulate the vibrating function when the device's paging frequency is summoned by the console 30. The viewing screen 90 may also be used in conjunction with audible alerts (not shown) to notify patrons of a page.

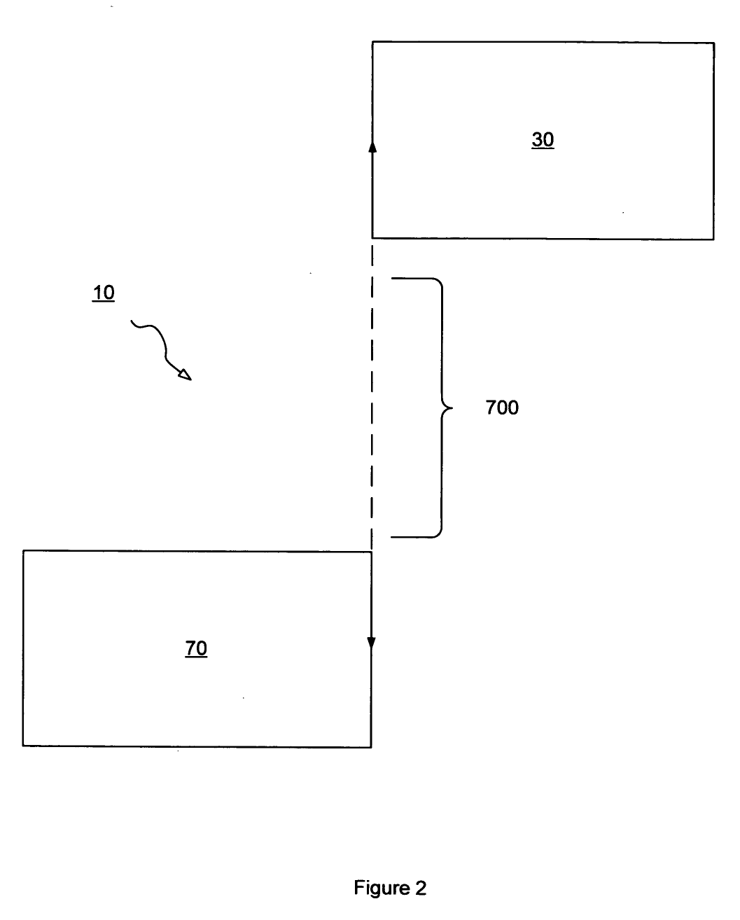

The console 30 may be used to transmit, upload or download media 700, such as games or advertising, to the remote media device 20 (as illustrated in FIG. 1) and/or the docking station 70 (as illustrated in FIG. 2).

An operating system 50 is compliant with both the console 30 and the remote media device 20. One suitable operating system 50 that may be used is the Microsoft® Mobile Platform, or the PALMS® OS.

Software may enable the device operations such as uploading or downloading information to enable the system or method to work. Software can enable subscription media to be used with the system. For example the vehicle by which the subscription media is transferred to the console 30 may be by computer readable media, such as compact discs (CD), digital video discs (DVD), read only memory (ROM), or downloadable content 700 from the internet or other external network source.

A docking station 70 may act as a medium or intersect, for data transfer, and, in one exemplary embodiment, have no physical memory.

However, in another exemplary embodiment, the docking station 70 could also be another wireless communications point to relay the signals to activate pagers, or send wireless media to the units.

In a further exemplary embodiment, the docking station 70 may be a conduit to recharge the remote media device 20, or to carry information from the console 30 to the docking station 70, whereby the docking station 70 retains at least some memory and information, which can then be transferred to the remote medial device 20.

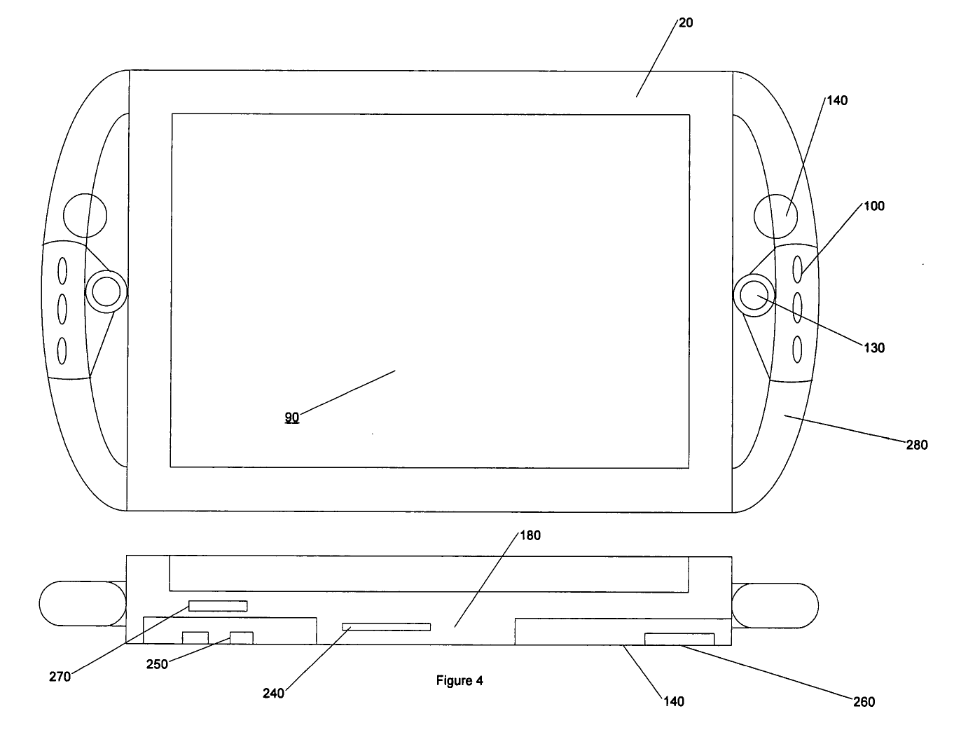

FIG. 3 illustrates one exemplary embodiment, whereby the remote media device 20 has a viewing screen 90, such as an LCD viewing screen. The screen 90 may be recessed and may have a cover 92 over the recessed screen to prevent debris such as food particles from entering cracks and openings that may otherwise exist. The remote media device 20 may have a transceiver of wireless communication device 180 to establish a wireless communication link between the remote media device 20 and the console 30. A mini-motherboard or memory chip 170 may be operable with the remote media device 20 for features inherent with standard motherboards, such as to run games and receive input. Input may be provided by the user's control of buttons 100 or a scrolling wheel 140. In one exemplary embodiment, the scrolling wheel 140 is operably secured on a curved handle 280 as illustrated in FIG. 4. In this exemplary embodiment, the remote media device 20 may be at least 6 inches in length by 6 inches in width or may be similar in size to a table PC. Alternatively, it may be the size of a wrist-watch. The wireless communication device 180 may be a wireless network card, or a network card to connect with LAN/WAN.

In one exemplary embodiment of the present invention, the remote media device 20 may be small, like a cell phone or personal data assistant (PDA), or larger, as discussed above, like a tablet personal computer. In either size, the remote media device 20 may be waterproof. This waterproof feature may be a rubberized coating over the entire device 20, and a transparent portion adjacent the viewing screen. Thus the screen may be waterproof, and viewable. Mylar® may be used to waterproof the remote media device 20.

In one exemplary embodiment, as seen in FIG. 4, the device 20 has handles 280 that are disposed rightwardly and leftwardly of the device 20, and have a curved shape. On the handles 280 are the buttons 100 and scrolling wheel 140. The buttons can further comprise separate buttons for direction control, and for selection. The handle 280 functions can be tailored for either right or left handed controls by selection of the buttons 100. A further exemplary embodiment of the present invention has a port 260 for the charging of re-chargeable batteries, synchronization, and/or for information exchanges, such as a Universal Serial Bus (USB) or Firewire® interface. The port 260 may be a PS/2 Port for a keyboard or mouse terminal.

A barcode scanner 270 may be integrated so that the remote media device 20 can scan barcodes.

The remote media device 20 may be equipped with a smart card slot 240, with a magnetic card reader operable with the smart card slot 240 to read information from such devices as driver's licenses, credit cards, or “frequent user” cards as part of a restaurant's marketing campaign. Liquor stores or gun stores may use to insert the drivers licenses of potential customers to check for probation violations, or criminal records before purchasing alcohol or guns, and also verify the authentication of drivers licenses or other forms of identification. Border security may use the remote media device 20 to verify licenses, credentials, or other forms of identification.

All ports or slots of the present invention may have protective airtight rubber (or other non-abrasive or oxidizing material) caps or plugs that would be inserted in them when not in use. Thus preventing damage to the unit through these access points.

One exemplary method of using the present invention 500 includes a remote media device 20 with various features 505, such as a tracking feature 510, to track game and media e.g. magazines or book usage so this information can be obtained for future marketing decisions. This tracking feature 510 would be similar to the existing task manager resource which operates within most operating systems to track which applications where run, and how frequently. The same process could also be used to debug the system and determine which programs or functions may be causing problems within the unit. This tracking feature 510 may track magazine content 700 accessed in a way similar to the way Internet Explorer® tracks the Internet history of sites visited. The media for articles may be simply added to the component as web media (via an Intranet or Internet network configuration), and the device would track each “hit” or view that the remote media device 20 has on each remote media device 20 by adding a history file or instance record into the “history” folder. This “history” folder may be dumped or downloaded into the console 30 or other storage, or downloaded to an internet web site to determine which content 700 was viewed, when it was viewed, and how often it was viewed for marketing purposes.

The remote media device 20 also may have an advertisement feature 520 can display advertisements for the user, or advertisements for third parties, such as suppliers, or whoever. The advertisement feature 520 can, for example, advertise “gear,” pharmaceutical company advertisements, particularly for hospitals, beer or wine in restaurants.

A loss prevention feature 530 is utilized by sounding an alarm at least one of the remote media device 20, the console 30, or the docking station 70 when the remote media device 20 is transported into an unauthorized zone. The unauthorized zone may be anywhere outside of the restaurant, or hospital. Alternatively the unauthorized zone may be a pre-determined radius from the console 30. A further exemplary embodiment of the loss prevention feature 530 is that the remote media device 20 may be disabled or functionless if transported into an unauthorized zone.

A map viewing feature 540 may also be used by the remote media device 20. This feature would be particularly useful when the entertainment paging system and method 10 is used in an amusement park. The map viewing feature 540 may display a map of an amusement park so patrons don't get lost. The paging feature 560 may be activated to inform the patron that “their roller coaster ride starts in 5 minutes,” or a similar notification. The paging feature may be simple illumination, or a buzzer sound, or words. In addition, the amusement park could advertise other attractions or “specials” for patrons, across the device.

A monitoring feature 570 may be used by the client, such as the amusement park to track the locations of patrons. The monitoring feature 570 may be a radio frequency identification (RFID) device placed within the remote media device 20.

The map viewing feature 540 within the remote media device 20 could also be particularly useful for tour groups or travel packages such as with cruise ships or all inclusive resorts. As in the amusement park example, the tourists could utilize these remote media devices to ensure that they will not get lost. These organizations could also utilize the monitoring feature 570 to track patron locations, and also notify them of advertisements and important events i.e. bus, ship, or travel arrangements are leaving soon.

The remote media device 20 may have an integrated electronic magazine-book viewing feature 580. This may be particularly useful for a large audience or for waiting rooms with longer than average waiting room times—where a person can have enough time to read a magazine article, or a few of them. The client, such as the restaurant, hospital, or amusement park may also be able to manage subscriptions based on patron history of reading, popularity of magazines, authors, or types of articles, i.e. sports, political news. The same information could also be vital to the content publishers and authors to verify and detect which types of media and content 700 are attracting patron attention.

An interactive form feature 590 may be integrated on the remote media device 20 so patrons can complete forms viewable via the remote media device 20, either with a stylus, a keyboard, or an “on-screen” keyboard. This may be particularly useful for hospitals, doctors' offices, or dentists' offices to gather basic information, insurance information, or to sign medical authorization forms. Then, via the client may simply upload the information. This information may be secure in the case of personal identifiable information, or medical records (according to the Health Insurance Portability and Accountability Act of 1996 (HIPAA). Using this interactive form feature 590 may reduce paper generation.

A game subscription feature 600 can be integrated within the system and method 10, whereby the client subscribes to use the games that are playable on the remote media device 20.

The loading of information 610 from the console to either the docking station 70 or the remote media device 20 may be through synchronization, such as plugging the device 20 into a Universal Serial Bus (USB) or Firewire® port 260. The battery recharger may be included as part of the port 260. Operative with the port 260 may be a further security feature, whereby only one specified port 260 may charge the device 20.

Operably attached to the port 260 may be the console 30; such as a computer, PC, laptop, PDA or other unit that may contain software to interface with the device 20 to load the content 700 from the console 30 to the device 20.

The port 260 may allow for the client to import information directly into the unit. This media 700 can be video games, advertisements, magazine subscriptions, magazine articles, books, or maps. This port 260 may also allow the client to directly export data from the device 20 that may specify the media used and the frequency of use. This data may allow the client to determine if certain media or subscriptions could be cancelled or removed, and if other media types should be given more focus or attention, i.e. if a game or magazine is not attracting attention, then it could be removed and replaced by a game or magazine type that is attracting more patron attention. This information could be used for data mining marketing techniques for a media supplier to determine the effectiveness of its media, and possibly the demographic makeup of their patron base. This technique would determine which advertisements would be better suited for that magazine subscription, and or client device.

The media content 700 can be either static or loaded on the device 20, or changed periodically in a subscription service type package. In these packages, the company can load new advertisements, games, magazines, books, and other information into the device 20. To control the access to the media content 700, a patron can use the buttons 100, such as the direction 110 and selection buttons 120, and the scrolling wheel 140.

To choose the media content 700, a patron would select from the remote media device 20 by using the buttons or wheel, 100, 110, 120, 140 to navigate across the screen. Then when a cursor or highlighted portion of the screen has identified certain media content 700, the patron can depress a pre-determined button or scrolling wheel, 100, 110, 120, 140. Further, the scrolling 100, 110, 120, 140 may be depressible as well as rotatable. For games the buttons and wheel 100, 110, 120, 140, may be used to shoot, grab, pass catch, etc. A thumb controller 130 may be disposed in one exemplary embodiment as seen in FIG. 4. For magazines or books, the patron could use the direction buttons or wheel 100, 110, 120, 140 to maneuver the cursor across the document, and selection buttons or wheel 100, 110, 120, 130, 140 to maneuver within the document or to turn the page. With respect to a map, the buttons or wheel 100,110, 120,140 may be used to move around the map.

Restaurants can use the system 10 for clientele waiting for tables, along with advertising sent to the device 20 for specific products, restaurant specials, or other topics of advertising that would be proper for the establishment.

Hospitals could also use the system 10 in waiting rooms. The hospitals may allow drug manufacturers to advertise on the device 20. The magazine-book viewing 580 feature may be employed here because wait times are generally longer, and the clientele is not always group oriented.

Amusement parks may use the system 10 for people waiting for rides. The map feature 540 may be used here. The amusement park may know the occupancy capacity of each ride, and the time it takes to run each ride and load and unload riders from the ride. Thus the amusement park may set up schedules for when its patrons should be at certain rides, and then calculate a wait period or time-frame. Further, if a wireless network is pre-existing, the information 700 may be passed along that network. This information could be in regards to promotions or advertising for the amusement park, so that the time saved by the patrons not waiting in line could be utilized to generate revenue at other park attractions.

This system and method 10 may also be used at the Secretary of State, Department of Motor Vehicles, Colleges or Government offices. One example of a wireless communication link described herein is a WiFi connection, as defined by the Institute of Electrical and Electronics Engineers (IEEE) 802.11x. The notation “x” is used because the 802.11 protocol has many revisions, and the specific revision is not important, so long as fast enough communication can be had. Other communication links may include, for shorter distances, communication using Bluetooth®. In addition, as communication protocols currently used in cell phones increases in bandwidth, such communication protocols will be seen just as applicable as today's WiFi technology.

In one exemplary embodiment, the console 30 may include a game system emulator or media emulator (not shown). The game system emulator or media emulator may take on a number of forms, such as software that emulates the processing performed by a game console and its respective hardware, software and firmware. When emulation is performed in software, the console 30 must be sufficiently powerful to emulate the processing performed by the hardware, software, and firmware of a game console.

The game system or media emulator can also take the form of hardware and firmware. When either emulator takes the form of hardware, similar hardware components present in a game console or PC with magazine reading software such as Zino® reader, would be integrated onto a printed circuit board and placed in communication with other circuitry of the content execution server.

Typically a game console or PC with magazine reading software may include a CPU, a graphics processor, memory, and specialized circuitry for handling graphics computations. The console 30 may have internal memory storage, or it may otherwise be connected to storage. Storage can take on any number of forms, such as for the console to be directly coupled to hard disk drives (not shown). When hard disk drives are used, a number of games or media can be stored on the hard disks, in a similar way that games or media are stored on compact discs.

It should be understood, of course, that the foregoing relates to exemplary embodiments of the invention and that modifications may be made without departing from the spirit and scope of the invention as set forth in the following claims.

I claim:

1. A method for rendering media content on a remote media device, comprising:
providing a console, said console capable of processing program instructions and sending a page;
communicating said processed program instructions over a communication link;
communicating said page over a wireless communication link; and
receiving said processed program instructions and said page at said remote media device, said remote media device capable of generating operations of said remote media device, said remote media device capable of activating as the result of receiving said page.

2. A method of claim 1, wherein said processed program instructions include data for generating said operations.

3. A method of claim 2, wherein said processed program instructions include data for generating advertising information that is viewable on a viewing screen of the remote media device.

4. A method of claim 1, wherein program code for the interactive program instructions of said media content is primarily stored and executed on the console.

5. A method of claim 1, wherein said communication link is a wireless communication link.

6. A method of claim 1, wherein said communication link is a wired communications link.

7. A method of claim 4, wherein said console includes a game system emulator, the game system emulator being configured to simulate processing by game console hardware and software.

8. A method for rendering media content on a remote media device as recited in claim 3, wherein said wireless communication link is bidirectional to enable the exchange of the control data during at least one of a game play, a reading of an electronic magazine or book, or a form completion.

9. A method of claim 1, wherein the remote media device is at least one of a handheld device or a tablet.

10. A method of claim 1, wherein said remote media device is capable of displaying electronic magazines and at least one of either said remote media device or said console is capable of tracking a magazine reading history.

11. An entertainment paging systems, comprising:
a console having a central processing unit that is capable of receiving, storing, and transmitting media content, said console also capable of sending a wireless page; and
a remote media device capable of receiving said page from said console, said remote media device also capable of allowing a user to interact with said media content.

12. The entertainment paging system of claim 11, wherein said remote media device has a protective transparent screen that is securely disposed above a recessed viewing screen.

13. The entertainment paging system of claim 11, wherein said remote media device is about the size of a typical personal data assistant.

14. The entertainment paging system of claim 11, wherein said remote media device has arcuate handles that extent leftwardly and rightwardly from said remote media device, whereby said remote media device is about the size of a tablet PC and is so dimensioned to be capable of operation by a user wearing gloves; said semi-circular handles has a control button that is capable of controlling some feature of the remote media device.

15. An entertainment paging system, comprising:
a console having a central processing unit, said console capable of receiving, storing, and transmitting media content said console also capable of sending a wireless page; and
a remote media device capable of receiving said page from said console, said remote media device also capable of interactive output of said media content.

16. The entertainment paging system of claim 15, wherein said remote media device has a protective transparent screen that is securely disposed above a recessed viewing screen.

17. The entertainment paging system of claim 15, wherein said remote media device is about the size of a typical personal data assistant.

18. The entertainment paging system of claim 15, wherein said remote media device has semi-circular handles that extent leftwardly and rightwardly from said remote media device, whereby said remote media device is about the size of a tablet PC and is so dimensioned to be capable of operation by a user wearing gloves; said semi-circular handles has a control button that is capable of controlling some feature of the remote media device.
